(19) United States
(12) Patent Application Publication
(10) Pub. No.: US 2014/0181145 A1
(43) Pub. Date: Jun. 26, 2014

(54) Modular Software System for Use in an Integration Software Technology and Method of Use

(71) Applicant: Jafer S. KAMSAMOHIDEEN, North Brunswick, NJ (US)

(72) Inventor: Jafer S. KAMSAMOHIDEEN, North Brunswick, NJ (US)

(21) Appl. No.: 14/139,633

(22) Filed: Dec. 23, 2013

Related U.S. Application Data
(60) Provisional application No. 61/746,037, filed on Dec. 26, 2012.

(51) Int. Cl. G06F 17/30

(52) U.S. Cl. CPC G06F 17/30483
USPC 707/776

(57) ABSTRACT

A modular software system for use with an integration software technology that facilitates an integration project by providing valuable information resources that assists in the development, deployment, and management on an integrated system as well as the resolution of any integration related issues. The module software system accomplishes this through the use of a plurality of modules and a method of use. The plurality of modules save time and effort involved in collecting a plurality of technical and non technical information required to make key decisions during the integration project implementation. By providing information in a packaged and organized way, the plurality of modules saves valuable and skilled resource man hours and effort reducing the cost spent on project implementation. The method of use allows project managers, technical team and business users to spend less time on collecting and organizing information before and during the implementation of an integration projects.

The current application claims a priority to the U.S. Provisional Patent application Ser. No. 61/746,037 filed on Dec. 26, 2012.

### FIELD OF THE INVENTION

The present invention relates generally to a system and method for a software integration product. More specifically, the software integration product allows a user to quickly integrate any software applications built on any technologies.

### BACKGROUND OF THE INVENTION

Businesses and individuals frequently need to perform various different business processes. Frequently, many different kinds of software are used for each kind of process. Integrating these different software systems can be very difficult and time consuming. Software integration activities require countless man hours, intensive labor, and heavy costs. The implementation of software integration projects is a difficult and expensive business process, and although there are software integration solutions available on the market, they suffer from several short comings that can complicate an integration project.

The currently available software integration solutions are a collection of software and hardware applications implemented as middleware designed to manage and coalesce hardware and software subsystem under a single unified system. The software integration solution can provides management handling tools that allow a system to exchange information from various sources and facilitate the development, deployment, and management of service oriented software architectures. These integration solutions are versatile systems primarily utilized in a business setting. While these systems facilitate many aspects of an integration project, they require highly trained development teams to ensure the successful deployment of the system.

It is therefore the object of the present invention to provide a modular software system for use with an integration software technology that facilitates an integration project by providing valuable information resources that assists in the development, deployment, and management on an integrated system as well as the resolution of any integration related issues. The module software system accomplishes this through the use of a plurality of modules and a method of use. The plurality of modules save time and effort involved in collecting a plurality of technical and non technical information required to make key decisions during the integration project implementation and maintenance. The method of use allows project managers, technical team and business users to spend less time on collecting and organizing information before and during the implementation of an integration projects. the plurality of modules accomplish this by providing information in a packaged and organized way that saves valuable and skilled resource man hours and effort reducing the cost spent on project implementation.

### BRIEF DESCRIPTIONS OF THE DRAWINGS

FIG. 1 is a block diagram displaying the component modules of the plurality of modules utilized by the modular software system as per the current embodiment of the present invention.

FIG. 2 is a flow chart diagram displaying a process overview for the method of utilization of the modular software system, as per the current embodiment of the present invention.

FIG. 3 is a flow chart diagraph displaying the method of utilization of the log miner module as per the current embodiment of the present invention.

FIG. 4 is a flow chart diagraph displaying a continuation of the method of utilization of the log miner module as per the current embodiment of the present invention.

FIG. 5 is a flow chart diagraph displaying a continuation of the method of utilization of the log miner module as per the current embodiment of the present invention.

FIG. 6 is a flow chart diagraph displaying the method of utilization of the searchable information database module as per the current embodiment of the present invention.

FIG. 7 is a flow chart diagraph displaying the steps of the SOP selection process as per the current embodiment of the present invention.

FIG. 8 is a flow chart diagraph displaying the continuation of the SOP selection process as per the current embodiment of the present invention.

FIG. 9 is a flow chart diagraph displaying the method of utilization of the fault handler module as per the current embodiment of the present invention.

FIG. 10 is a flow chart diagraph displaying the method of utilization of the integration scheduler module as per the current embodiment of the present invention.

FIG. 11 is a flow chart diagraph displaying the method of utilization of the incident manager module as per the current embodiment of the present invention.

### DETAIL DESCRIPTIONS OF THE INVENTION

All illustrations of the drawings are for the purpose of describing selected versions of the present invention and are not intended to limit the scope of the present invention.

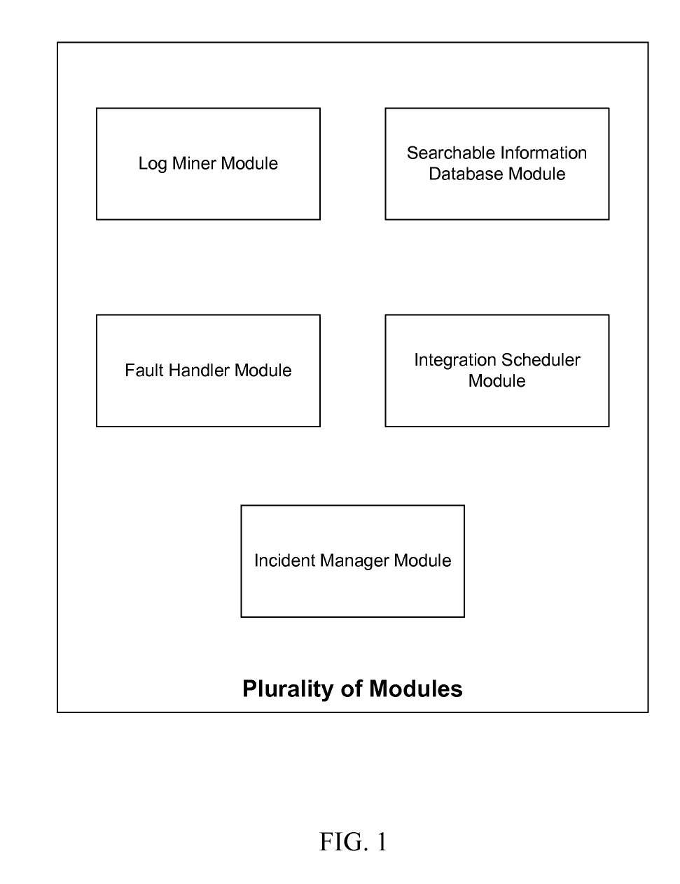

Referencing FIG. 1, the present invention is a modular software system that provides additional features and services to an implemented integration software technology. The modular software system provides development, deployment, and management features and services that facilitate the integration of existing hardware and software subsystem into a unified system by the integration software technology. The present invention accomplishes this through a method of utilization on an integrated system and the use of a plurality of modules that further improve the functionality of an existing integration software technology. In the current embodiment of the present invention, the plurality of modules comprise a log miner module, a searchable information database module, a fault handler module, an integration scheduler module, and an incident manager module. The log miner module aggregates and decodes log files generated by all integration related application servers of the plurality of hardware and software subsystems and displays them in a user interfaces. The searchable information database module functions as a quick access and searchable resource that provides a user with installation guides and a plurality of integration specific answers for various stages of an integration project. The searchable information database module additionally provides access to a plurality of standard operating procedures to guide a user throughout the integration project. Furthermore the searchable information database module comprises pre-built and implementable Guided user interfaces for improving the appearance of the integration project. The fault handler module is an application service that utilizes user defined faults to identify unwanted behaviors performed by the hardware and software subsystems of the integrated system. The integration scheduler module is provided as an automated service programmed by a user to initiate in integration process following a particular event such as a behavior or a pre-defined time and date. The integration incident manager provides a user a means to create a new ticket for production related issues in order to track and fix. The integration incident manager utilizes the searchable information database in order to provide a user with solutions to issues commonly seen in an integration project.

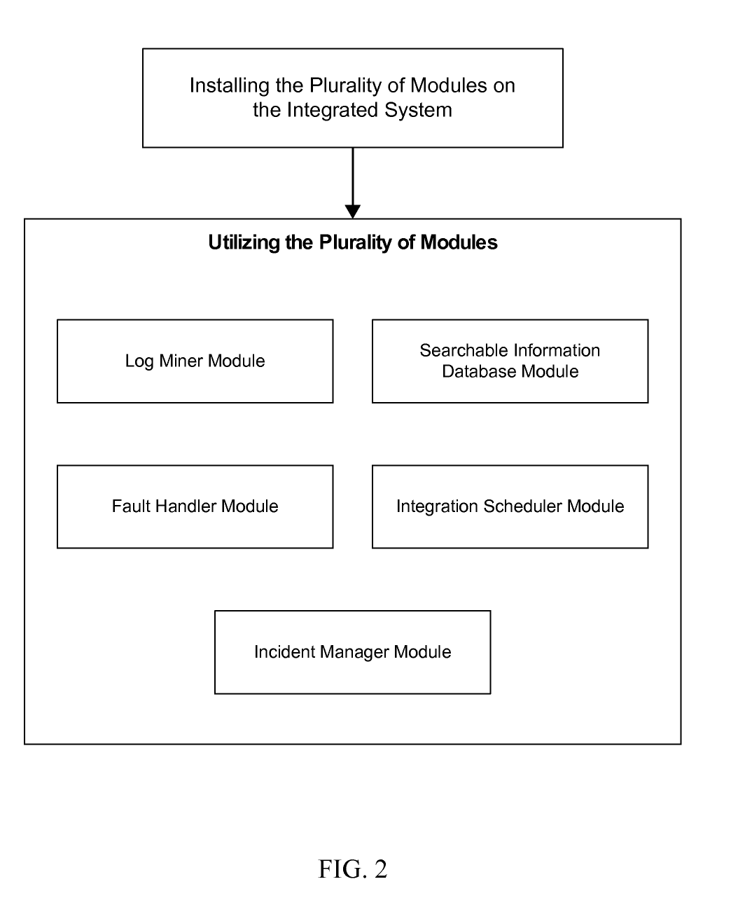

Referencing FIG. 2, the method of utilization of the modular software system on an integrated system comprises the steps of installing the plurality of modules on the integrated system, utilizing the log miner module, utilizing the searchable information database module, utilizing the fault handler module, utilizing the integration scheduler module, and utilizing the incident manger module. The initial step of installing the plurality of modules on the integrated system is initiated by the user, who installs the plurality of modules on network accessible drives. The network accessible drives are any storage location on the integrated system that are able to communicate with other network accessible drives. The network accessible drives may be found on a particular hardware subsystem such as a server or a particular piece of hardware. Following the installation of the plurality of modules on the network accessible drives, a user is able to utilize the log miner module, the searchable information database module, the fault handler module, the integration scheduler module, or the incident manager module.

Referencing FIG. 1, the plurality of modules each comprise individual method steps that ensure their functionality on the integrated system. While the individual method steps utilized by each module may vary dependent on the particular stage of the integration project and the particular integration software technology, each module is able to carry out their primary functions independently if needed. Furthermore while each module is described as being able to function independently, each module will operate cohesively with another module upon its activation or initiation in order to facilitate and improve functionality of the integration software technology.

The log miner module is installed on a network accessible drive and on a plurality of hardware subsystems. The network accessible drive is provided as the same drive that the integration software technology is installed on. it should be noted that the modular software system is installed on a network accessible drive to ensure that the plurality of modules are able to communicate with the plurality of hardware and software subsystems as well as to reduce interaction delays between the plurality of modules and the integration software technology.

The log miner module receives information from various hardware subsystems, refines, and displays collected information in a user readable table. The log miner module accomplishes this task through the use of various subcomponents and a particular set of steps dictating their use. In the current embodiment of the present invention, the log miner module is provided a displayable data table, an inbound directory, a database, and a processor installed on a network accessible drive, and an agent installed on the network accessible drives of the plurality of hardware subsystems.

The displayable data table is a provided as a user viewable window containing information derived from a plurality of log files in a table format. In the current embodiment of the present invention, displayable data table is provided in the form of a SQL table that shows various data table entries where each entry is associated with a particular log file collected and converted by the log miner module.

The agent functions primarily as a log file transmitter for a particular hardware subsystem. The agent is installed on the plurality of hardware subsystems as a means of transmitting log files of the hardware subsystem to the inbound directory. The agent is responsible for locating and transmitting subsystem created log files. The agent can additionally document hardware subsystem interactions and create log files.

The installation of the inbound directory, the database, and the processor, on the network accessible drive provide functionality to the log miner module. The inbound directory serves as a depository for receiving a plurality of log files from the plurality of hardware subsystems. It should be noted that the plurality of log files consist of various log file types due to the various types of hardware subsystems. Each log file of the plurality of log files comprises an identifier and a plurality of raw data values. The identifier is utilized by the processor to determine the log file type of the log file. The plurality of raw data values are hardware or software process information that is converted by the processor into meaningful information to be displayed as an entry in a data table.

The processor detects and identifies the plurality of log files received by the inbound directory. The processor identifies the log file type of each log file received by reading the log file and detecting known identifiers that correspond to a log file type in the database. In the preferred embodiment of the present invention, the identifiers are delimiters, an arrangement of delimiters, or a specific header that is found within the first few lines of a log file. The processor extracts the plurality of raw data values from a log file. The processor uses the known conversion process to convert the plurality of raw data values into meaningful information. The processor uses the converted data values to create a data table entry for each log file.

If the processor detects unknown identifiers in a log file, the processor creates a new log file type in the database for an unknown log file type. The processor extracts the plurality of raw data values. The processor analyzes the plurality of raw data values extracted from the unknown log file and compares it to the plurality of raw data values associated with known log file types. Based on the closest matching log file type, the processor creates a new data table entry and a new conversion process. The processor associates the new data table entry and the new conversion process with the new log file type and prompts a user to verify the information when displayed in the displayable data table.

The database functions as a repository that holds a plurality of log file types that are accessible for viewing by the processor. Each log file type of the plurality of log file types are either initially provided upon installation of the log miner module or are created by the processor and verified by a user. The processor communicates with the database in order to access the plurality of log file types. Each log file type of the plurality of log file types contains a known identifier, a known conversion processes, and a known data table entry format. It should be noted that the database can associated with the searchable information database as their functions overlap and are both user accessible and user editable.

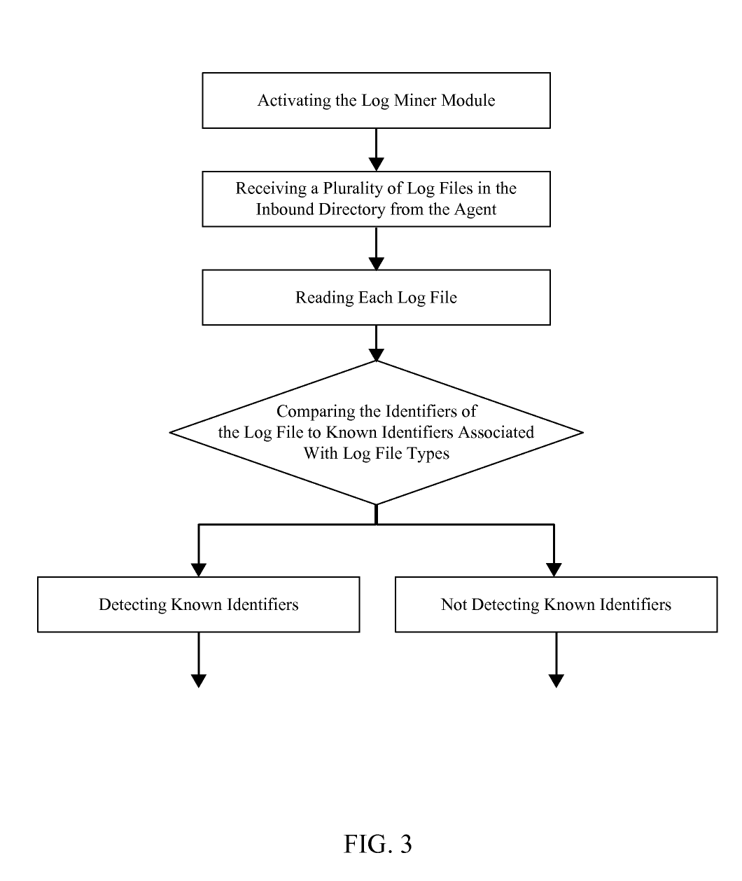

Referencing FIGS. 3 5, the method of utilizing the log miner module comprises several steps. The activation of the log miner module is the initial step of the method. The activation of the log miner module may occur through a user initiated command line prompt, through user activation through a guided user interface, or automatically following the installation of the plurality of modules. With the activation of the log miner module, the inbound directory receives a plurality of log files from an agent on a hardware subsystem. The processor reads each log file for identifiers of each log file received in the inbound directory. The processor compares the identifiers of the log file received in the inbound directory to known identifiers associated with log file types in the database. The comparison of the identifiers by the processor will result in the detection of known identifiers or the detection of unknown identifiers, where each out has their own set of steps.

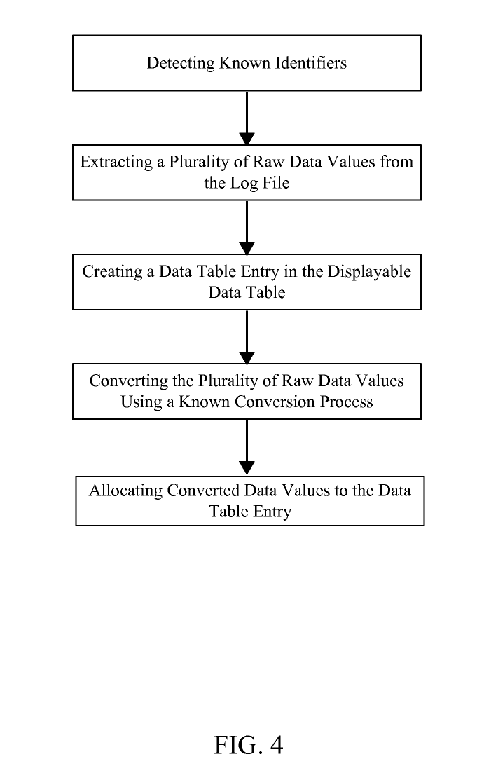

Referencing FIG. 4, if the processor detects known identifiers in the log file associated with a log file type in the database, the processor extracts the plurality of raw data values from the log file and creates data table entry in the displayable data table. The processor uses a data table entry format associated with the known log file type in order to create the data table entry. With the data table entries created, the processor converts the plurality of raw data values extracted from the log file using a known conversion process associated with the known log file type. One the data table entry has been filled by the processor, the displayable data table presents the information to the user through a guided user interface.

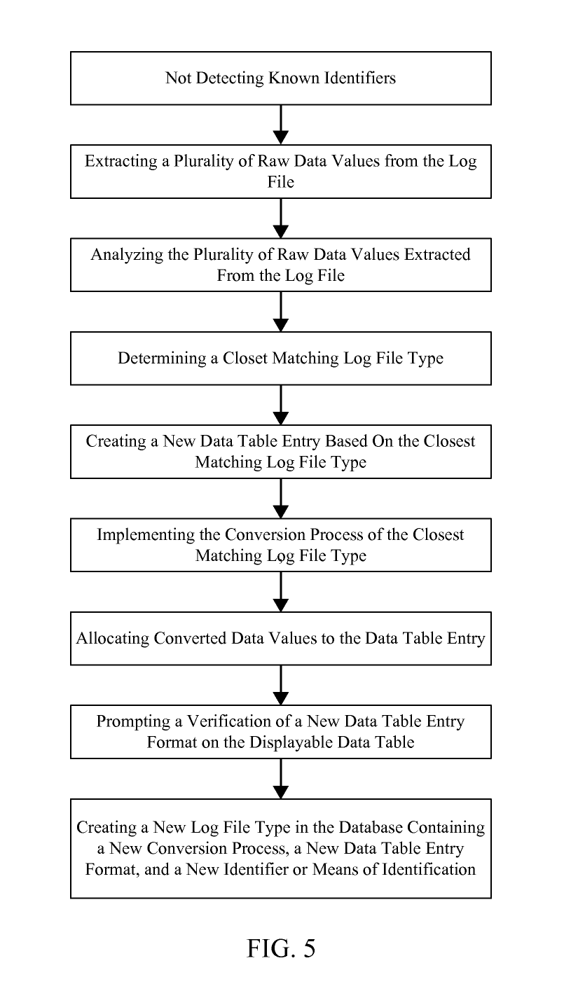

Referencing FIG. 5, if the processor does not detect identifiers or detects identifiers in the log file not associated with a known log file type in the database, the processor extracts the plurality of raw data values from the log file in order to perform an analysis. The processor analyzes the plurality of raw data values extracted from the log file and compares the extracted raw data values to raw data value types associated with a known log file type. The processor determines the closest matching log file type based on the comparison of the raw data values. Based on the closest matching log file type, the processor creates a new data table entry. The processor then implements the conversion process of the closest matching log file type. The processor then allocates the converted data values into the data table entry. Upon presenting the new data table entry on displayable data table, the processor prompts the user for verification the new data table entry format. Following the verification of the new data table entry format, the processor creates a new log file type in the database containing a new conversion process, a new data table entry format, and new identifier or means of identification for the unknown log file.

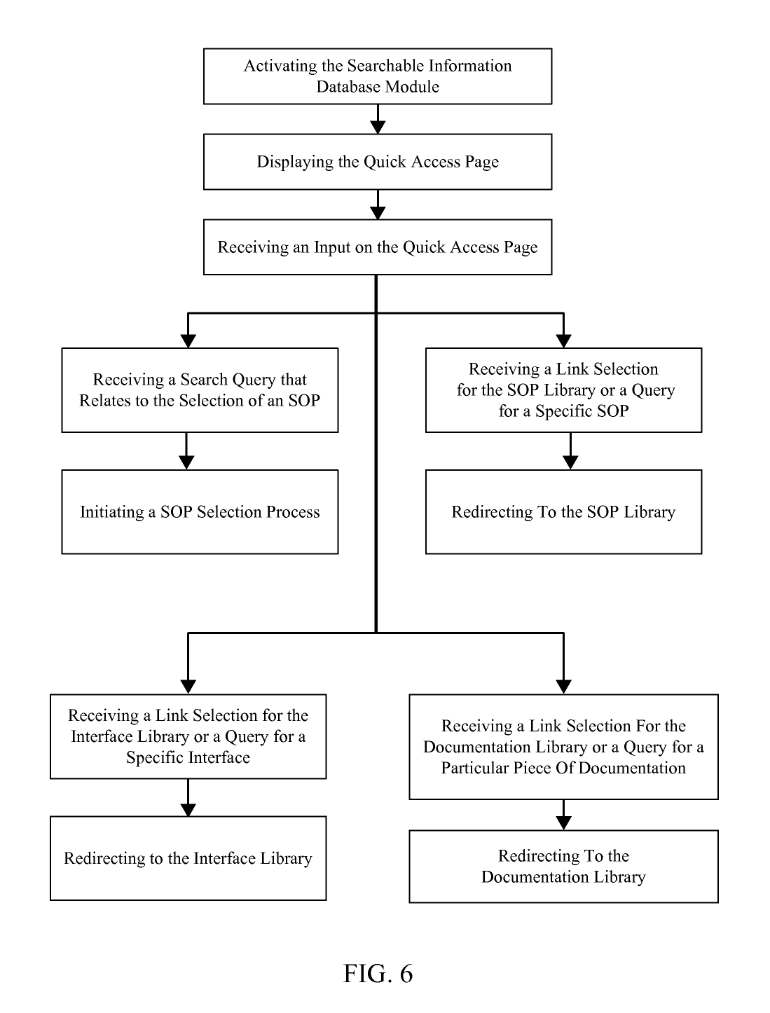

Referencing FIG. 6, the searchable information database module functions as a quick access page that allows a user to search through various libraries that provide a user with installation guides and a plurality of integration specific answers relate to an integration project. The searchable information database module additionally provides access to a plurality of standard operating procedures to guide a user throughout the integration project. The searchable information database module has an option permitting the user to enter new documents, as well as links and server details. The searchable information database module is installed on a network accessible drive. The network accessible drive provides the searchable information database with access to local and network repositories to retrieve documents or files. The searchable information database module comprises a plurality of libraries that include a standard operating procedure (SOP) library, an interface library, and a documentation library. The SOP library comprises documentation containing installation instruction and troubleshooting instructions related to most integration projects. The interface library comprises preconfigured interfaces to be deployed in an integration environment. The preconfigured interfaces can serves as proof of concept interfaces that later be manipulated or configured to fit the specific needs of the integration project. The documentation library comprises various document types that provide additional information and resources relating to a particular integration project.

The quick access page is the user interface for the searchable information database. The quick access page comprises links to the SOP library, the interface library, and the documentation library. The quick access page additionally provides a link or a means that allows the user to upload, update, and revise information on the database.

The sop library comprises documentation that contains installation and troubleshooting instructions that are useful during an integration project. in the current embodiment of the present invention, the sop library comprises a technology selection SOP, a Technology Training SOP, a Technology Product Evaluation SOP, a proof of concept (POC) Environment SOP (Platform and Key Interfaces Plan, Design, Build), a proof of concept (POC) Environment Evaluation SOP, a Project Planning SOP, an Infrastructure Platform Design SOP, an Application Design SOP, an Interface Consolidation and Design SOP, an Applications per Platform Consolidation SOP, an Interfaces per Platform Consolidation SOP, an Infrastructure build SOP, an Interfaces development SOP, a Backup and Recovery SOP, a Change Management Process SOP, a Deployment Automation SOP, a Production Support Process SOP, a Production Release SOP, a Support Process 5 Automation SOP, and a Training SOP.

The technology selection SOP is an instructional document that assists a user in the selection of the appropriate integration technology to utilize in their integration implementation project. The technology selection SOP provides the user with instruction for the installation of all necessary applications to ensure the most appropriate technology is selected for the integration implementation project. The Technology Training SOP is an instructional document that provides a user with the necessary information to familiarize themselves with a particular integration technology. The technology training SOP additionally provides the user with necessary support for development and deployment of the particular integration technology. The Technology Product Evaluation SOP is an instructional document that provides the user with the necessary information to test an implemented integration technology through the use of several proof of concept integration environments. The proof of concept (POC) Environment SOP (Platform and Key Interfaces Plan, Design, Build) is an instruction document that guides a user to deploy a proof of concept integration environment. The proof of concept (POC) Environment Evaluation SOP is an instructional document that guides a user to determine the success of the integration technology through the evaluation of the proof of concept integration environment through the functionality of various interrelated application assets. The Project Planning SOP is an integration environment related SOP document that provides the user with instructions on how to plan the deployment of future integration projects within the established integration environment. The Infrastructure Platform Design SOP is an integration environment related SOP document that provides the user with instructions on how to develop and design the necessary infrastructure within the integration environment to ensure successful deployment of future integration projects. The Application Design SOP is an integration environment related SOP document that provides the user with instruction on how to design and develop applications to function within the integration environment. The Interface Consolidation and Design SOP is an integration environment related SOP document that provides the user with guide on how to consolidate interfaces from various integrated hardware or software subsystems. The Applications per Platform Consolidation SOP is an integration environment related SOP that serves as an installation guide for installing applications that will be utilized in the integration environment. The Interfaces per Platform Consolidation SOP is an integration environment related SOP that serves as an installation guide for installing interfaces that consolidate interactions with the installed applications. The Infrastructure build SOP is an integration environment related SOP that provides the development instructions for an infrastructure build. The Interfaces development SOP is an integration environment related SOP that serves as an instructional guide for developing interfaces for use in the integration environment. The Backup and Recovery SOP is an integration environment related SOP that provides resources for backing up and recovering integration environment states. The Change Management Process SOP, the Deployment Automation SOP, and the Production Support Process SOP, SOP are production release SOPs.

The interface library comprises preconfigured interfaces to be deployed in an integration environment. In the current embodiment of the present invention, the interface library comprises an Integration Interface to Email integration errors, an Interface to integrate queue, an Interface to integrate file transfer, an Interface to integrate databases, an Interfaces to Integrate EDI, an Interface to integrate B2B clients, an Interface to integrate ERP Applications, an Interface to integrate Legacy Applications, an Interface to ping remote hosts, an Interface to lookup configuration values, and an Interface to purge files and data.

The documentation library comprises various document types that provide additional information and resources relating to a particular integration project. in the current embodiment of the present invention the documentation library comprises Articles on Integration Technologies, Documents on Integration Products, Documents on Best Practices, Documents on Development Techniques, Audio and Video files on Subject Matters, Installation Guides, List of Tools and Software, Sample Code, Sample Architecture Designs, Sample Project Plans, and Templates.

Referencing FIG. 6, the method of utilizing the searchable information database module comprises several steps. The activation of the searchable information database occurs as the initiation step for the method of use. Upon receiving a user interaction the searchable information database module displays a quick access page. It should be noted that a user interaction can be any interaction such as a command line prompt, link selection through a guided user interface, or a defined interaction related to a fault or error message initiated by the user. With the quick access page displayed, an input would be received in the form of a link selection, or a search query.

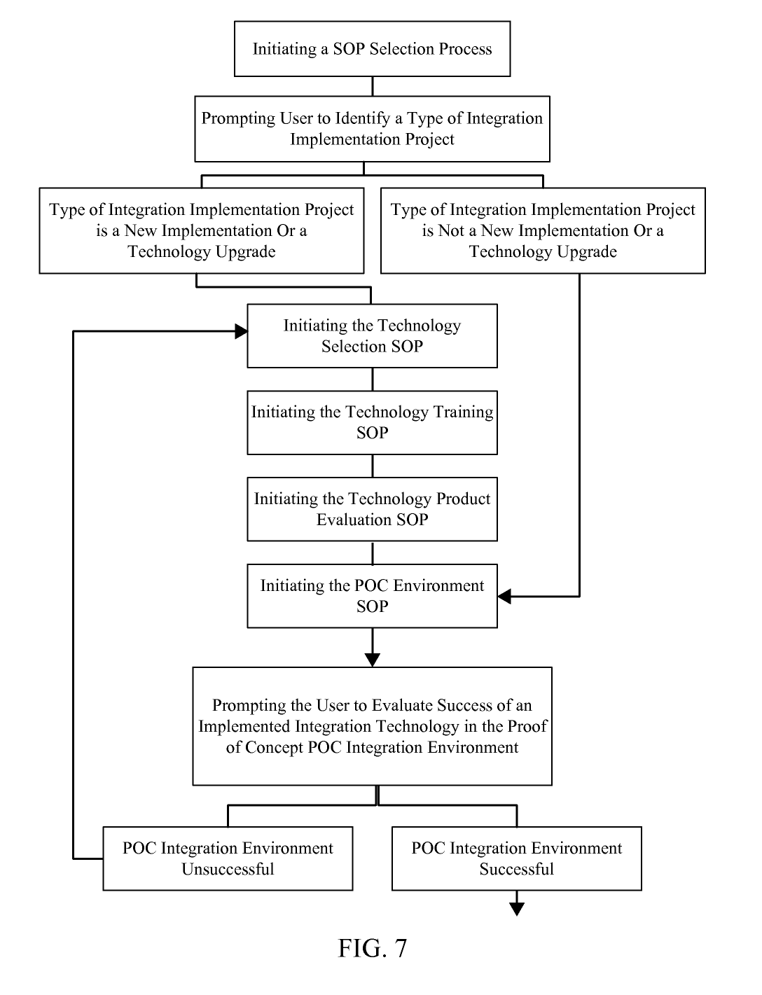

Referencing FIG. 7, if the searchable information database module receives an input or a search query that relates to the selection of an SOP, the searchable information database module initiates an SOP selection process. The SOP selection process prompts a user to identify a type of integration implementation project. The type of integration implementation projects are a new integration project and a technology upgrade. The input selection of the new integration project or the technology upgrade as the type of integration implementation projects initiates the technology selection SOP. The technology selection SOP provides the user with an instructional guide for selecting the most appropriate integration technology to use for the integration implementation project. Following the selection of an integration technology, the technology training SOP is initiated. The technology training SOP provides the user with the training information related to the selected integration technology. With the completion of the technology training SOP, the technology product evaluation SOP is initiated. The technology product evaluation SOP is an instructional document containing information need to test an implemented integration technology through the use of several proof of concept integration environments. Following the completion of the technology product evolution SOP, a proof of concept (POC) Environment SOP is intimated. The proof of concept (POC) Environment SOP is an instruction document that guides a user to deploy a proof of concept integration environment in order to test the implemented integration product. In the event that neither integration project is selected than the Sop selection process determines that the user does not need assistance in selecting an integration technology to implement and initiates the proof of concept (POC) Environment SOP. The initiation of the proof of concept (POC) Environment SOP provides the user with instructions on how to deploy a POC integration environment to test an implemented integration technology of an existing integration product.

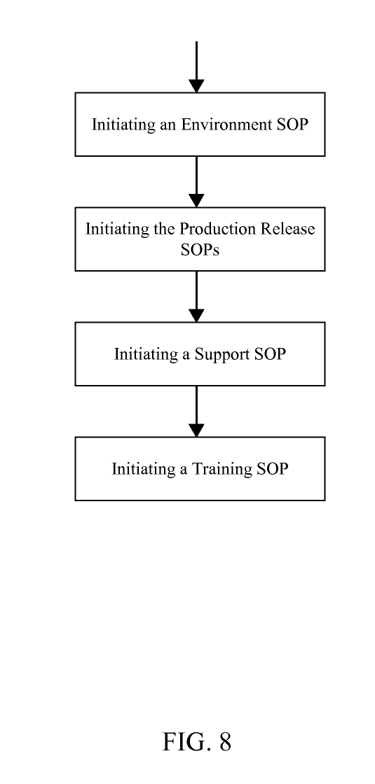

Referencing FIG. 8, if the implementation of a POC integration environment, the SOP selection process prompts the user to evaluate the success of an implemented integration technology in the POC integration environment. If the implemented integration technology is evaluated as being successful in the POC integration environment, an environment SOP is selected. Environment SOPs are the Project Planning SOP, the Infrastructure Platform Design SOP, the Application Design SOP, the Interface Consolidation and Design SOP, the Applications per Platform Consolidation SOP, the Interfaces per Platform Consolidation SOP, the Infrastructure build SOP, the Interfaces development SOP, and the Backup and Recovery SOP, help develop and manage the implemented integration technology for the particular integration project. Following the completion of the environment SOPs, a production release SOP is initiated. The production release SOPs are the Change Management Process SOP, the Deployment Automation SOP, and the Production Support Process SOP, provide the user with instructional information for completing and releasing the integration project for general use. With the completion of the production release SOPs, the system initiates support SOPs and training SOPs. The support SOPs and the Training SOPs are provided as SOPs for dealing with the implemented integration technology following its release for general use.

In the event that the implemented integration technology is evaluated as being unsuccessful in the POC integration environment, the SOP selection process restarts the technology selection SOP. The technology selection SOP is initiated to re-determine an integration technology to implement in the integration project. upon selected an integration technology, SOP selection process initiates the technology training SOP, the technology product evaluation SOP, and the POC environment SOP, in order to re-evaluate the success of the implemented integration technology.

If the searchable information database module receives a link selection for the SOP library or a query for a specific SOP, the searchable information database module redirects to the sop library. The selection of a SOP library link will redirect the user to the SOP library to facilitate their selection of a particular SOP. Although the SOP selection process is used to determine the selection of a particular SOP, receiving a search query for an SOP will redirect the user to the SOP library. Redirecting the user to the SOP library provides a list of SOPs that most closely match the search query. In some cases where a very specific search query is submitted for a particular integration technology, the development, deployment, or management of an integration environment, or a particular product release SOP, the redirect will continue to the closest matching SOP.

If the searchable information database module receives a link selection for the interface library or a query for a specific interface, the searchable information database module redirects to the interface library. The selection of an interface library link will redirect the user to the interface library to facilitate their selection of a particular interface. Redirecting the user to the interface library provides a list of interfaces that most closely match the search query. From this location the user can select, retrieve, and send a particular interface they would like to use in their integration project.

If the searchable information database module receives a link selection for the documentation library or a query for a particular piece of documentation, the searchable information database module redirects to the documentation library. The selection of a documentation library link will redirect the user to the documentation library to facilitate their selection of a particular file. Redirecting the user to the documentation library provides a list of files that most closely match the search query.

The fault handler module is an application service that utilizes user defined faults to identify unwanted behaviors performed by the hardware and software subsystems of the integrated system. The fault handler module is installed on a network accessible drive. The installation location provides the fault handler module with access to the plurality of hardware and software subsystem and the plurality of implemented integration technologies installed on the integrated system. The fault handler module is able to use the network accessible drives connectivity to monitor interactions. The fault handler module is provided with a plurality of user defined application faults each comprising event identifiers. The plurality of user defined application faults are a collection of user specified interactions or behaviors performed by the integration technology or its associated applications that perform an unwanted or undesired behavior. The user can provide a detailed description of the interaction or behavior as well as any information that would be useful to resolve or prevent the particular interaction. The plurality of user defined application faults each comprise event identifiers which are defined by the user. The event identifiers are a set of conditions that can be detected the fault handler module. The set of conditions can be predefined value ranges, a system status, or any detectable event that correspond to a particular behavior or interaction performed by an integration technology or an associated application.

Each of the plurality of user defined application faults comprise an email alert protocol. The email alert protocol is provided as a set of protocols for notifying a user of an application fault. The email alert protocol contains user defined email information to forward a notification upon the detection of a specific application fault.

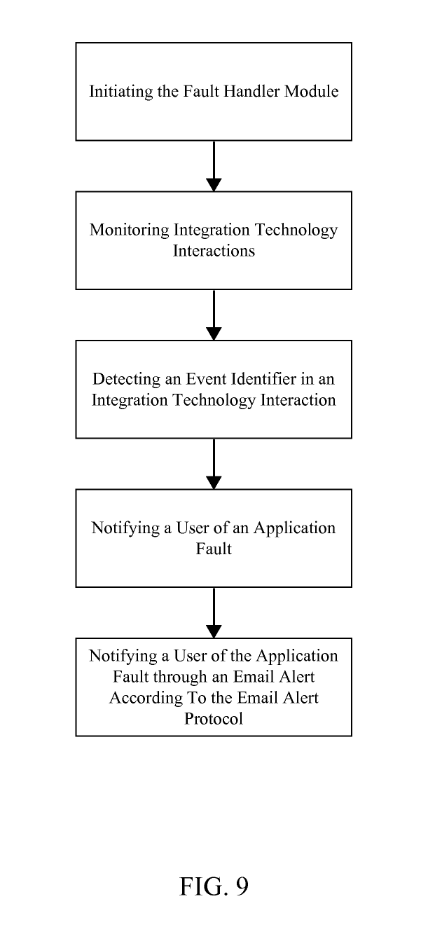

Referencing FIG. 9, the method of utilizing the fault handler module comprises several steps. The activation of the fault handler module occurs as the initiation step for the method of use. The fault handler is activated upon the creation of a user defined application faults. Following activation, the fault handler module monitors integration technology interaction for event identifiers. It should be noted that the fault handler module can work in tandem with the log miner module to monitor integration technology interaction. The fault handler module continually monitors the interactions until an event identifier is detected. Upon detecting an event identifier in an integration technology interaction, the fault handler module notifies the user. The fault handler module can notify the user through a user interface message or through any detectable means. Each of the plurality of user defined application faults comprises an email alert protocol which provides a specific means of notifying a user of a particular application fault. The email alert protocol contains the specific information provided by the user to alert create and send an email alert in response to the detection of the particular application fault.

The integration scheduler module is provided as an automated service programmed by a user to initiate in integration process following a particular event such as a behavior or a pre-defined time and date. The integration scheduler module is installed on a network accessible drive. The installation location provides the integration scheduler module communication with the plurality of implemented integration technologies that are installed on the implemented system. The integration scheduler module is able to use the network accessible drives connectivity to interact with the implemented integration technologies. The integration scheduler module is provided with a plurality of user defined scheduled processes each comprising an event condition and a scheduled process. The plurality of user defined scheduled processes provide the integration scheduler module with multiple event dependent interactions to perform on specific implemented integration technologies. Each user defined scheduled process comprises an event condition that serves as the initiator commences the scheduled process. The event condition can be a behavior, an interaction, or a specific time or date that is detected by the integration scheduler module. The scheduled process is the specific interaction or processes that are activated upon detection of the event condition.

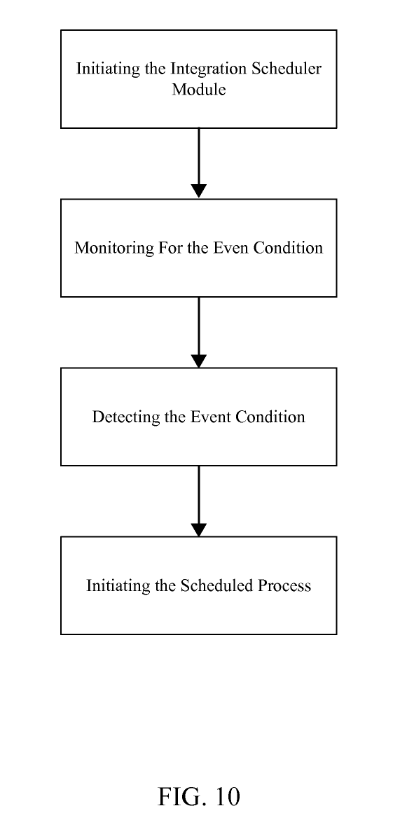

Referencing FIG. 10, the method of utilizing the integration scheduler module comprises several steps. The activation of the integration scheduler module occurs as the initiation step for the method of use. The fault handler is activated upon the creation of a user defined scheduled process. Following activation, the integration scheduler module monitors the integrated system to detect if the event conditions are met. The integration scheduler module continually monitors for the event conditions to be met. Upon detecting the event conditions integration scheduler module initiates the scheduled process on an integration technology or an associated application. The event condition can occur on a set interval of time if needed.

The integration incident manager module provides a user a means to create a new ticket for production related issues in order to track and fix. The integration incident manager module utilizes the searchable information database in order to provide a user with solutions to issues commonly seen in an integration project. The integration incident manager module is installed on a network accessible drive. The installation location provides the integration incident manager module with communication to the plurality of implemented integration technologies that are installed on the implemented system. The integration incident manager module is provided with a production related incident ticket comprising a production specific integration incident and an incident resolution. The production related incident ticket is a user created documentation file that is related to a production related issue that occurs in an implemented integration technology following a production release. The production specific integration incident is the event or action that is associated with the production related incident ticket. The incident resolution is a user created or system provided solution to the production specific integration incident. It should be noted that the incident resolution can be provided as a documentation file that discloses the solution for a particular production specific integration incident. In an embodiment of the invention, the incident resolution can be a documentation file can be located on the searchable information database.

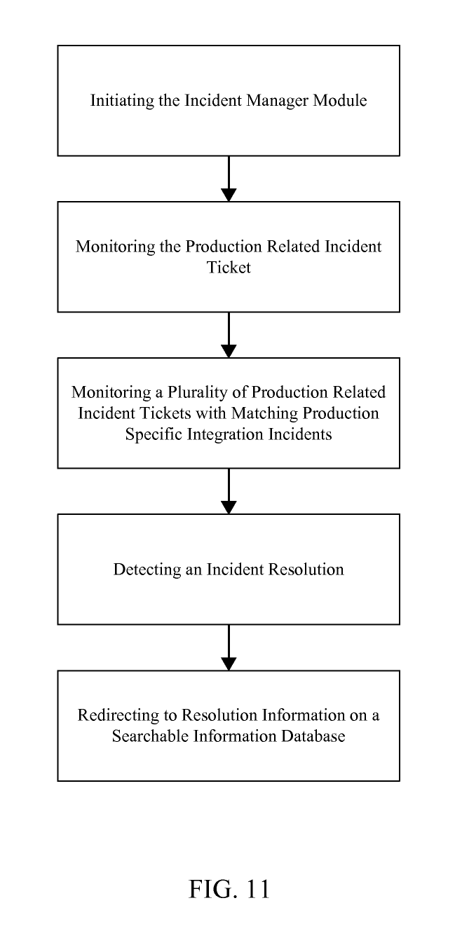

Referencing FIG. 11, the method of utilizing the incident manager module comprises several steps. The activation of the incident manager module occurs as the initiation step for the method of use. Following the activation, the incident manager module monitors the production related incident ticket created by a user. The incident manager module additionally monitors a plurality of production related incident tickets with matching production specific integration incidents. Upon detecting an incident resolution the incident manager module redirects to resolution information on a searchable information database in order resolve the production related incident ticket.

In an embodiment of the invention, the log miner module mines the log generated by all the integration related application servers, this application has its unique algorithm to decode the log files and load them into user interfaces. It also takes input from users to identify the different components of the log records. This module helps the production support personnel to quickly debug and resolve any integration server issues, thus helping the application to reduce downtime.

In an embodiment of the invention, the searchable information database module serves as quick access page for all the documents, links and servers which are related to integration environment. It has an option for the users to enter new documents, links and server details. It also serves as a quick launch page. The searchable information database module has a prebuilt list of sop for various common tasks which integration implementation needs.

In an embodiment of the invention, the fault handler module allows users to define new application faults and a detail description for quicker tracking of errors thrown by integration applications. It also provides email alert options pro-actively monitor certain user defined errors and codes.

In an embodiment of the invention, the integration scheduler module is a prebuilt process to allow users to schedule any integration process to run on a scheduled time. The users can add processes, select the time and date it needs to be run. They can enter the max number of run the processes will be run.

In an embodiment of the invention, the incident management module allows users to create new ticket for production related issues and track the fix. This module also has prebuilt list of issues and solution common to integration projects. This helps the support team to quickly fix most of the common issues without much time to research and find the solution.

In an embodiment of the invention, the modular software system comprises a plurality of modules, plug-ins, and a plurality of integration related files. the modular software system comprises, automation routines, pre-built environments, adapters, B2B plug-ins and know how, error handler and scheduler, 20 middleware libraries, sample programs, custom pre-built interfaces, industry standard architecture, internal data transfer plug-ins, clean up processes, deployment automation and knowhow, application security plug-ins and knowhow, source control plug-ins and knowhow, user management plug-ins and knowhow, identity management and knowhow and plug-ins, backup plug-ins and knowhow, and a log miner application and knowhow.

The Automation of routines are documents on how to automate common tasks for integration implementation and support team. The Pre-built environments are templates environment with sample configuration values, which can be used to build new environment. The Adapters list all the commonly available open source adapters for quick access and use. The adapters provide documents and links to proprietary adapters after a written permission from the owners. The B2B plug-ins and knowhow list all the commonly available open source plug-ins for quick access and use. The B2B plug-ins and knowhow provide documents and links to proprietary plug-ins after a written permission from the owners. The Error handler is a pre-build error handler module for easy install and use. The 20 Middleware libraries are sets of documents which help the middleware experts to keep informed about industry news. The Sample programs are a few sample codes for few common development tasks, the development team can use it as a template. A custom pre-built interface to be used as an example for building programs which helps to build real time interfaces for publishing and subscribing to industry common queues like jms.mq. Documents on how it works, how to use them. The Industry standard architecture knowhow and sample solutions are Documents on standard practices and principles used in building integration architecture. Sample architecture diagrams which can be used as template. The Internal data transfer plug-ins and knowhow are Prebuilt interfaces to transfer data from one application to another. The Internal data transfer plug-ins and knowhow contain documents on how it works and how to integrate them into any integration implementation. A scheduler program to run processes which needs to be run a periodic time. The Cleanup processes and knowhow a prebuilt scripts for cleaning log files and historic data, the integration implementation can use it off the self instead of creating their own. The cleanup process and knowhow provides documentation on how to use this process and how it works details. The Deployment automation and knowhow a prebuilt process which allows the implementation team to deploy the developed code to the target applications. Also it provides documentation on how to use this process and how it works details. The Application security plug-ins and knowhow are rebuilt interfaces to mask data being transferred between applications, apply security on application user's access. The Source control plug-ins and knowhow are Prebuilt Processes to manage source code, document on how to use that process into an integration implementation project. The User management plug-ins and knowhow are Custom plug-in interfaces to create users for the application access, query the application users and manage their roles and privileges. The Identity management knowhow and plug-ins provide a knowledge base on identity management products available in the market and prebuilt interfaces for common tasks. The Backup plug-ins and knowhow are prebuilt process to back up and restore the environment. The knowhow are documents on how it works and how to add that into any integration implementation projects. The Log miner application and knowhow is a prebuild java based log miner process. The log miner application includes documents on how to configure and add to integration implementation projects.

Although the invention has been explained in relation to its preferred embodiment, it is to be understood that many other possible modifications and variations can be made without departing from the spirit and scope of the invention as hereinafter claimed.

What is claimed is:

1. A method of utilizing a modular software system within an integration software technology by executing computer-executable instructions stored on a non-transitory computer-readable medium, comprises the steps of:
providing a plurality of modules, wherein the plurality of modules comprise a log miner module, a searchable information database module, an integration scheduler module, a fault handler module, and an integration incident manager module;
providing an integration software technology, wherein the integration technology is a collection of software and hardware applications implemented as middleware in order to manage or coalesce a plurality of hardware and software subsystems;
providing an integrated system, wherein the integrated system is a system comprised of hardware and software subsystem managed or coalesced by the integration software technology;
installing the plurality of modules on the integrated system;
utilizing the log miner module on the integrated system;
utilizing the searchable information database module;
utilizing the fault handler module;
utilizing the integration scheduler module; and
utilizing the incident manager module.

2. The method of utilizing the log miner module on the integrated system by executing computer-executable instructions stored on a non-transitory computer-readable medium, as claimed in claim 1 comprises the steps of:
providing a displayable data table;
providing an agent installed on network accessible drives of the plurality of hardware subsystems;
providing an inbound directory, a database, and a processor installed on a main network accessible drive;
activating the log miner module;
receiving a plurality of log files in the inbound directory, wherein the plurality of log files are transmitted by the agent on the hardware subsystems;
reading each log file received in the inbound directory, wherein the processor reads each log file for identifiers;
comparing the identifiers of a log file received in the inbound directory to known identifiers associated with log file types in the database;
extracting a plurality of raw data values from the log file,
creating a data table entry in the displayable data table, wherein the processor creates the data table entry based on a data table entry format associated with the known log file type,
converting the plurality of raw data values using a known conversion process, wherein the processor uses the known conversion process associated with the known log file type,
allocating converted data values to the data table entry,
if the processor detects known identifiers in the log file associated with a log file type in the database; and
extracting a plurality of raw data values from the log file,
analyzing the plurality of raw data values extracted from the log file, wherein the processor compares raw data values extracted from the log file to raw data value types associated with a known log file type,
determining a closet matching log file type,
creating a new data table entry based on the closest matching log file type,
implementing the conversion process of the closest matching log file type,
allocating converted data values to the data table entry,
prompting a verification of a new data table entry format on the displayable data table,
creating a new log file type in the database containing a new conversion process, a new data table entry format, and a new identifier or means of identification,
if the processor does not detect identifiers or detects identifiers in the log file not associated with a known log file type in the database.

3. The method of utilizing the searchable information database module on the integrated system by executing computer-executable instructions stored on a non-transitory computer-readable medium, as claimed in claim 1 comprises the steps of:
providing the SOP library comprising a technology selection SOP, a Technology Training SOP, a Technology Product Evaluation SOP, a proof of concept (POC) Environment SOP (Platform and Key Interfaces Plan, Design, Build), a proof of concept (POC) Environment Evaluation SOP, a Project Planning SOP, an Infrastructure Platform Design SOP, an Application Design SOP, an Interface Consolidation and Design SOP, an Applications per Platform Consolidation SOP, an Interfaces per Platform Consolidation SOP, an Infrastructure build SOP, an Interfaces development SOP, a Backup and Recovery SOP, a Change Management Process SOP, a Deployment Automation SOP, a Production Support Process SOP, a Production Release SOP, a Support Process 5 Automation SOP, and a Training SOP;
providing the interface library comprising an Integration Interface to Email integration errors, an Interface to integrate queue, an Interface to integrate file transfer, an Interface to integrate databases, an Interfaces to Integrate EDI, an Interface to integrate B2B clients, an Interface to integrate ERP Applications, an Interface to integrate Legacy Applications, an Interface to ping remote hosts, an Interface to lookup configuration values, and an Interface to purge files and data;
providing the documentation library comprising Articles on Integration Technologies, Documents on Integration Products, Documents on Best Practices, Documents on Development Techniques, Audio and Video files on Subject Matters, Installation Guides, List of Tools and Software, Sample Code, Sample Architecture Designs, Sample Project Plans, and Templates;
providing a quick access page comprising links to the SOP library, the interface library, and the documentation library;
activating the searchable information database module;
displaying the quick access page;
receiving an input on the quick access page;
initiating a SOP selection process,
if the searchable information database module receives a search query that relates to the selection of an SOP;
redirecting to the sop library,
if the searchable information database module receives a link selection for the SOP library or a query for a specific SOP;
redirecting to the interface library,
if the searchable information database module receives a link selection for the interface library or a query for a specific interface; and
redirecting to the documentation library,
if the searchable information database module receives a link selection for the documentation library or a query for a particular piece of documentation.

4. The method of selecting a SOP from the SOP library by executing computer-executable instructions stored on a non-transitory computer-readable medium, as claimed in claim 3 comprises the steps of:
prompting user to identify a type of integration implementation project;
initiating the technology selection SOP,
initiating the technology training SOP,
initiating the technology product evaluation SOP,
initiating the POC environment SOP,
if the type of integration implementation project is selected as a new implementation, or as a technology upgrade;
initiating the POC environment SOP,
if the type of integration implementation project is not selected as a new implementation or as a technology upgrade;
prompting the user to evaluate the success of an implemented proof of concept POC integration environment;
initiating an environment SOP, where the environment SOPs are the Project Planning SOP, the Infrastructure Platform Design SOP, the Application Design SOP, the Interface Consolidation and Design SOP, the Applications per Platform Consolidation SOP, the Interfaces per Platform Consolidation SOP, the Infrastructure build SOP, the Interfaces development SOP, and the Backup and Recovery SOP,
initiating the production release SOPs, where the production release SOPs are the Change Management Process SOP, the Deployment Automation SOP, and the Production Support Process SOP,
initiating a support SOP,
initiating a training SOP,
if the implemented integration technology is evaluated as being successful in the POC integration environment; and
initiating the technology selection SOP,
initiating the technology training SOP,
initiating the technology product evaluation SOP,
initiating the POC environment SOP,
if the implemented integration technology is evaluated as being unsuccessful in the POC integration environment.

5. The method of utilizing the fault handler module on the integrated system by executing computer-executable instructions stored on a non-transitory computer-readable medium, as claimed in claim 1 comprises the steps of:
providing a plurality of user defined application faults each comprising event identifiers;
initiating the fault handler module;
monitoring integration technology interactions;
detecting an event identifier in an integration technology interaction;
notifying a user of an application fault;

6. The step of notifying the user of the application fault by executing computer-executable instructions stored on a non-transitory computer-readable medium, as claimed in claim 5 additionally comprises the steps of:
providing the plurality of user defined application faults each comprising an email alert protocol; and
notifying a user of the application fault through an email alert according to the email alert protocol.

7. The method of utilizing integration scheduler module on the integrated system by executing computer-executable instructions stored on a non-transitory computer-readable medium, as claimed in claim 1 comprises the steps of:
providing a plurality of user defined scheduled process each comprising an event condition and a scheduled process;
initiating the integration scheduler module;
monitoring for the even condition;
detecting the event condition; and
initiating the scheduled process.

8. The method of utilizing the incident manager module on the integrated system by executing computer-executable instructions stored on a non-transitory computer-readable medium, as claimed in claim 1 comprises the steps of:
providing a production related incident ticket comprising a production specific integration incident and an incident resolution;
initiating the incident manager module;
monitoring the production related incident ticket;
monitoring a plurality of production related incident tickets with matching production specific integration incidents;
detecting an incident resolution; and
redirecting to resolution information on a searchable information database.

9. A method of utilizing a modular software system within an integration software technology by executing computer-executable instructions stored on a non-transitory computer-readable medium, comprises the steps of:
providing a plurality of modules, wherein the plurality of modules comprise a log miner module, a searchable information database module, an integration scheduler module, a fault handler module, and an integration incident manager module;
providing an integration software technology, wherein the integration technology is a collection of software and hardware applications implemented as middleware in order to manage or coalesce a plurality of hardware and software subsystems;
providing an integrated system, wherein the integrated system is a system comprised of hardware and software subsystem managed or coalesced by the integration software technology;
providing a displayable data table;
providing an agent installed on network accessible drives of the plurality of hardware subsystems;
providing an inbound directory, a database, and a processor installed on a main network accessible drive;
providing the SOP library comprising a technology selection SOP, a Technology Training SOP, a Technology Product Evaluation SOP, a proof of concept (POC) Environment SOP (Platform and Key Interfaces Plan, Design, Build), a proof of concept (POC) Environment Evaluation SOP, a Project Planning SOP, an Infrastructure Platform Design SOP, an Application Design SOP, an Interface Consolidation and Design SOP, an Applications per Platform Consolidation SOP, an Interfaces per Platform Consolidation SOP, an Infrastructure build SOP, an Interfaces development SOP, a Backup and Recovery SOP, a Change Management Process SOP, a Deployment Automation SOP, a Production Support Process SOP, a Production Release SOP, a Support Process 5 Automation SOP, and a Training SOP;
providing the interface library comprising an Integration Interface to Email integration errors, an Interface to integrate queue, an Interface to integrate file transfer, an Interface to integrate databases, an Interfaces to Integrate EDI, an Interface to integrate B2B clients, an Interface to integrate ERP Applications, an Interface to integrate Legacy Applications, an Interface to ping remote hosts, an Interface to lookup configuration values, and an Interface to purge files and data;
providing the documentation library comprising Articles on Integration Technologies, Documents on Integration Products, Documents on Best Practices, Documents on Development Techniques, Audio and Video files on Subject Matters, Installation Guides, List of Tools and Software, Sample Code, Sample Architecture Designs, Sample Project Plans, and Templates;
providing a quick access page comprising links to the SOP library, the interface library, and the documentation library; providing a plurality of user defined application faults each comprising event identifiers; providing a production related incident ticket comprising a production specific integration incident and an incident resolution;
providing a plurality of user defined scheduled process each comprising an event condition and a scheduled process;
installing the plurality of modules on the integrated system;
activating the log miner module;
receiving a plurality of log files in the inbound directory, wherein the plurality of log files are transmitted by the agent on the hardware subsystems;
reading each log file received in the inbound directory, wherein the processor reads each log file for identifiers;
comparing the identifiers of a log file received in the inbound directory to known identifiers associated with log file types in the database;
extracting a plurality of raw data values from the log file,
creating a data table entry in the displayable data table, wherein the processor creates the data table entry based on a data table entry format associated with the known log file type,
converting the plurality of raw data values using a known conversion process, wherein the processor uses the known conversion process associated with the known log file type,
allocating converted data values to the data table entry,
if the processor detects known identifiers in the log file associated with a log file type in the database;
extracting a plurality of raw data values from the log file,
analyzing the plurality of raw data values extracted from the log file, wherein the processor compares raw data values extracted from the log file to raw data value types associated with a known log file type,
determining a closet matching log file type,
creating a new data table entry based on the closest matching log file type,
implementing the conversion process of the closest matching log file type,
allocating converted data values to the data table entry,
prompting a verification of a new data table entry format on the displayable data table,
creating a new log file type in the database containing a new conversion process, a new data table entry format, and a new identifier or means of identification,
if the processor does not detect identifiers or detects identifiers in the log file not associated with a known log file type in the database;
activating the searchable information database module;
displaying the quick access page;
receiving an input on the quick access page;
initiating a SOP selection process,
if the searchable information database module receives a search query that relates to the selection of an SOP;
redirecting to the sop library,
if the searchable information database module receives a link selection for the SOP library or a query for a specific SOP;
redirecting to the interface library,
if the searchable information database module receives a link selection for the interface library or a query for a specific interface;
redirecting to the documentation library,
if the searchable information database module receives a link selection for the documentation library or a query for a particular piece of documentation;
initiating the fault handler module;
monitoring integration technology interactions;
detecting an event identifier in an integration technology interaction;
notifying a user of an application fault;
initiating the integration scheduler module;
monitoring for the even condition;
detecting the event condition;
initiating the scheduled process;
initiating the incident manager module;
monitoring the production related incident ticket;
monitoring a plurality of production related incident tickets with matching production specific integration incidents;
detecting an incident resolution; and
redirecting to resolution information on a searchable information database.

10. The method of selecting a SOP from the SOP library by executing computer-executable instructions stored on a non-transitory computer-readable medium, as claimed in claim 9 comprises the steps of:
prompting user to identify a type of integration implementation project;
initiating the technology selection SOP,
initiating the technology training SOP,
initiating the technology product evaluation SOP,
initiating the POC environment SOP,
if the type of integration implementation project is selected as a new implementation, or as a technology upgrade;
initiating the POC environment SOP,
if the type of integration implementation project is not selected as a new implementation or as a technology upgrade;
prompting the user to evaluate the success of an implemented proof of concept POC integration environment;
initiating an environment SOP, where the environment SOPs are the Project Planning SOP, the Infrastructure Platform Design SOP, the Application Design SOP, the Interface Consolidation and Design SOP, the Applications per Platform Consolidation SOP, the Interfaces per Platform Consolidation SOP, the Infrastructure build SOP, the Interfaces development SOP, and the Backup and Recovery SOP,
initiating the production release SOPs, where the production release SOPs are the Change Management Process SOP, the Deployment Automation SOP, and the Production Support Process SOP,
initiating a support SOP,
initiating a training SOP,
if the implemented integration technology is evaluated as being successful in the POC integration environment; and
initiating the technology selection SOP,
initiating the technology training SOP,
initiating the technology product evaluation SOP,
initiating the POC environment SOP,
if the implemented integration technology is evaluated as being unsuccessful in the POC integration environment.

11. The step of notifying the user of the application fault by executing computer-executable instructions stored on a non-transitory computer-readable medium, as claimed in claim 9 additionally comprises the steps of:
providing the plurality of user defined application faults each comprising an email alert protocol; and
notifying a user of the application fault through an email alert according to the email alert protocol.

12. A method of utilizing a modular software system within an integration software technology by executing computer-executable instructions stored on a non-transitory computer-readable medium, comprises the steps of:
providing a plurality of modules, wherein the plurality of modules comprise a log miner module, a searchable information database module, an integration scheduler module, a fault handler module, and an integration incident manager module;
providing an integration software technology, wherein the integration technology is a collection of software and hardware applications implemented as middleware in order to manage or coalesce a plurality of hardware and software subsystems;
providing an integrated system, wherein the integrated system is a system comprised of hardware and software subsystem managed or coalesced by the integration software technology;
providing a displayable data table;
providing an agent installed on network accessible drives of the plurality of hardware subsystems;
providing an inbound directory, a database, and a processor installed on a main network accessible drive;
providing the SOP library comprising a technology selection SOP, a Technology Training SOP, a Technology Product Evaluation SOP, a proof of concept (POC) Environment SOP (Platform and Key Interfaces Plan, Design, Build), a proof of concept (POC) Environment Evaluation SOP, a Project Planning SOP, an Infrastructure Platform Design SOP, an Application Design SOP, an Interface Consolidation and Design SOP, an Applications per Platform Consolidation SOP, an Interfaces per Platform Consolidation SOP, an Infrastructure build SOP, an Interfaces development SOP, a Backup and Recovery SOP, a Change Management Process SOP, a Deployment Automation SOP, a Production Support Process SOP, a Production Release SOP, a Support Process 5 Automation SOP, and a Training SOP;
providing the interface library comprising an Integration Interface to Email integration errors, an Interface to integrate queue, an Interface to integrate file transfer, an Interface to integrate databases, an Interfaces to Integrate EDI, an Interface to integrate B2B clients, an Interface to integrate ERP Applications, an Interface to integrate Legacy Applications, an Interface to ping remote hosts, an Interface to lookup configuration values, and an Interface to purge files and data;
providing the documentation library comprising Articles on Integration Technologies, Documents on Integration Products, Documents on Best Practices, Documents on Development Techniques, Audio and Video files on Subject Matters, Installation Guides, List of Tools and Software, Sample Code, Sample Architecture Designs, Sample Project Plans, and Templates;
providing a quick access page comprising links to the SOP library, the interface library, and the documentation library; providing a plurality of user defined application faults each comprising event identifiers; providing a production related incident ticket comprising a production specific integration incident and an incident resolution;
providing the plurality of user defined application faults each comprising an event identifier and an email alert protocol;
providing a plurality of user defined scheduled process each comprising an event condition and a scheduled process;
providing a production related incident ticket comprising a production specific integration incident and an incident resolution;
installing the plurality of modules on the integrated system;
activating the log miner module;
receiving a plurality of log files in the inbound directory, wherein the plurality of log files are transmitted by the agent on the hardware subsystems;
reading each log file received in the inbound directory, wherein the processor reads each log file for identifiers;
comparing the identifiers of a log file received in the inbound directory to known identifiers associated with log file types in the database;
extracting a plurality of raw data values from the log file,
creating a data table entry in the displayable data table, wherein the processor creates the data table entry based on a data table entry format associated with the known log file type,
allocating converted data values to the data table entry,
converting the plurality of raw data values using a known conversion process, wherein the processor uses the known conversion process associated with the known log file type,
if the processor detects known identifiers in the log file associated with a log file type in the database;
extracting a plurality of raw data values from the log file,
analyzing the plurality of raw data values extracted from the log file, wherein the processor compares raw data values extracted from the log file to raw data value types associated with a known log file type;
determining a closet matching log file type;
creating a new data table entry based on the closest matching log file type,
implementing the conversion process of the closest matching log file type,
allocating converted data values to the data table entry,
prompting a verification of a new data table entry format on the displayable data table,
creating a new log file type in the database containing a new conversion process, a new data table entry format, and a new identifier or means of identification,
if the processor does not detect identifiers or detects identifiers in the log file not associated with a known log file type in the database,
activating the searchable information database module,
displaying the quick access page,
receiving an input on the quick access page,
prompting user to identify a type of integration implementation project,
initiating the technology selection SOP,
initiating the technology training SOP,
initiating the technology product evaluation SOP,
initiating the POC environment SOP,
if the type of integration implementation project is selected as a new implementation, or as a technology upgrade,
initiating the POC environment SOP,
if the type of integration implementation project is not selected as a new implementation or as a technology upgrade,
prompting the user to evaluate the success of an implemented proof of concept POC integration environment,
initiating an environment SOP, where the environment SOPs are the Project Planning SOP, the Infrastructure Platform Design SOP, the Application Design SOP, the Interface Consolidation and Design SOP, the Applications per Platform Consolidation SOP, the Interfaces per Platform Consolidation SOP, the Infrastructure build SOP, the Interfaces development SOP, and the Backup and Recovery SOP,
initiating the production release SOPs, where the production release SOPs are the Change Management Process SOP, the Deployment Automation SOP, and the Production Support Process SOP,
initiating a support SOP,
initiating a training SOP,
if the implemented integration technology is evaluated as being successful in the POC integration environment,
initiating the technology selection SOP,
initiating the technology training SOP,
initiating the technology product evaluation SOP,
initiating the POC environment SOP,
if the implemented integration technology is evaluated as being unsuccessful in the POC integration environment,
if the searchable information database module receives a search query that relates to the selection of an SOP;
redirecting to the sop library,
if the searchable information database module receives a link selection for the SOP library or a query for a specific SOP;
redirecting to the interface library,
if the searchable information database module receives a link selection for the interface library or a query for a specific interface;
redirecting to the documentation library,
if the searchable information database module receives a link selection for the documentation library or a query for a particular piece of documentation;
initiating the fault handler module;
monitoring integration technology interactions;
detecting an event identifier in an integration technology interaction;
notifying a user of an application fault through an email alert according to the email alert protocol;
initiating the integration scheduler module;
monitoring for the even condition;
detecting the event condition;
initiating the scheduled process;
initiating the incident manager module;
monitoring the production related incident ticket;
monitoring a plurality of production related incident tickets with matching production specific integration incidents;
detecting an incident resolution; and
redirecting to resolution information on a searchable information database.
